(19) United States
(12) Patent Application Publication
(10) Pub. No.: US 2005/0237742 A1
(43) Pub. Date: Oct. 27, 2005

(54) Combination of hose nozzle and flashlight

(76) Inventor: Gary Wang, ChangHua (TW)

Correspondence Address: Gary Wang, P.O. Box 487, ChangHua City, TW

(21) Appl. No.: 10/828,198

(22) Filed: Apr. 21, 2004

(51) Int. Cl. F21L 4/00

(52) U.S. Cl. 362/253

(57) ABSTRACT

A hose nozzle includes a flashlight received therein and a head portion of the flashlight is located in a head member connected to the barrel of the nozzle. The head portion of the flashlight is engaged with a central hole of the pattern plate in the head member so that water may go through apertures defined through the pattern plate. A control set for controlling the flashlight is connected to a rear end of the barrel and can be accessible from outside of the nozzle so that the flashlight can be operated independent from the hose nozzle.

### FIELD OF THE INVENTION

The present invention relates to a water hose nozzle in which a flashlight is connected so as to provide illumination during a dark area.

### BACKGROUND OF THE INVENTION

A conventional water hose nozzle generally includes a barrel with a spray nozzle at a front end thereof and a handle. A hose is connected to the handle so as to provide water into the nozzle and the water goes out from the spray nozzle. The conventional water hose nozzle has only one function and performs as a valve so as to control whether or not the water may go out from the spray nozzle such that the user can sprinkle the plants at a distance from the faucet. If the user wants to sprinkle the plants at night and no light device is available, the user cannot see the plants clearly.

The present invention intends to provide a water hose nozzle which has a flashlight located in a center thereof such that the nozzle can be used in a dark area.

### SUMMARY OF THE INVENTION

The present invention relates to a multi-function nozzle which comprises a handle and a barrel which is connected to the handle. A passage is defined through the handle and communicates with a hollow interior of the barrel so that a hose can be connected to the handle so as to provide water into the barrel. A head member is connected to a front open end the barrel and a pattern plate is engaged with the head member. A flashlight is located in the head member and connected to the pattern plate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the nozzle and the flashlight of the present invention;

FIG. 2 is an exploded view to show the control set for the flashlight of the present invention;

FIG. 3 is a side view to show the combination of the nozzle and the flashlight of the present invention;

FIG. 4 shows the rear end of the combination of the nozzle and the flashlight of the present invention;

FIG. 5 is a cross sectional view to show the combination of the nozzle and the flashlight of the present invention;

FIG. 5-1 shows the engagement of the tongue of the head member and the recess in the barrel of the nozzle, and

FIG. 6 is a cross sectional view to show another embodiment of the present invention.

### DETAILED DESCRIPTION OF THE PREFERRED EMBODIMENT

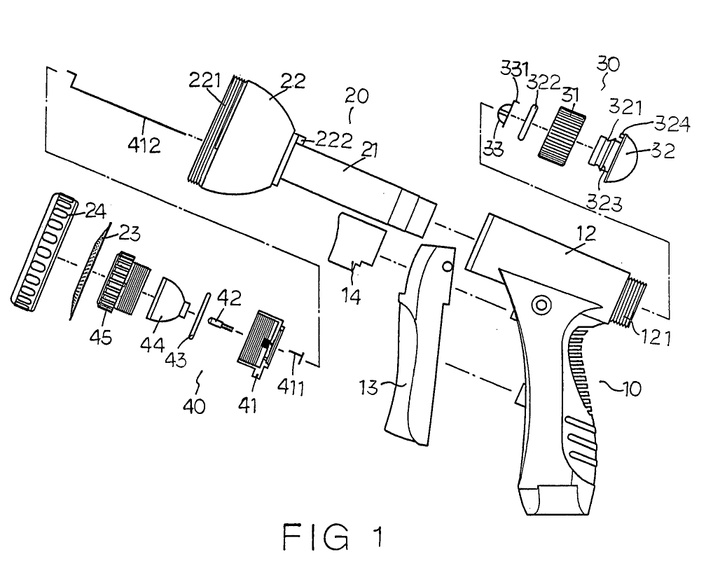

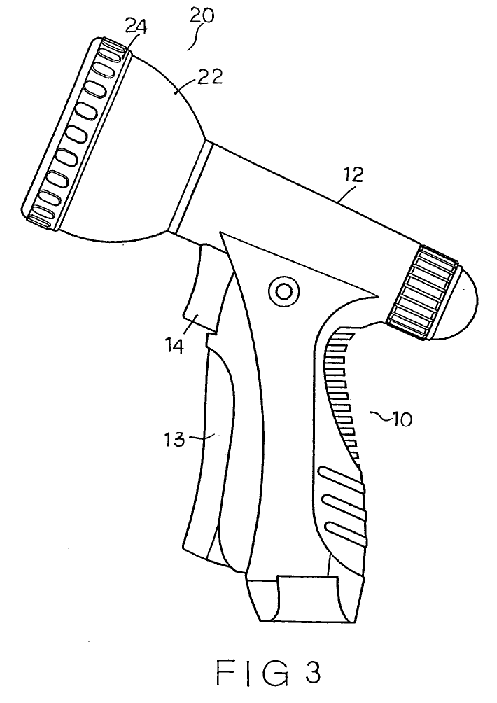

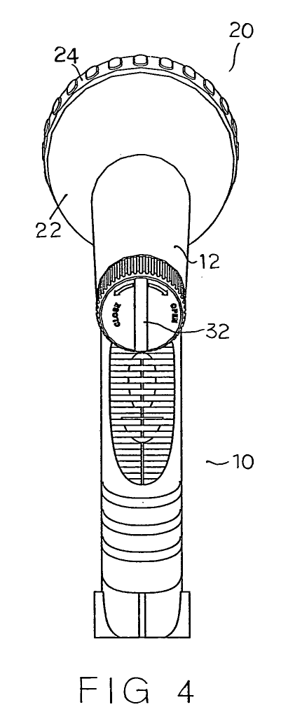

Referring to FIGS. 1, 3, 4 and 5, the multi-function nozzle of the present invention comprises a handle 10 and a barrel 12 which is connected to the handle 10. A passage 11 is defined through the handle 10 and communicates with a hollow interior of the barrel 12 so that the handle 10 can be connected to a hose so as to introduce water into the barrel 12 via the passage 11. A trigger 13 is pivotably connected to the handle 10 and is capable to control the introduction of the water through the passage 11. A locking piece 14 is connected to the trigger 13 so as to lock the trigger 13 at a desired position.

A head member 22 is mounted to a flashlight 20 and connected to a front open end of the barrel 12. The head member 22 includes a tongue 222 extending from a rear end thereof and a recess 122 is defined in the inner periphery of the barrel 12 so that the tongue 222 is engaged with the recess 122.

The flashlight 20 includes a body 21 for receiving batteries and a head portion 40. The body 21 is received in the barrel 12 and the head portion 40 extends from a front open end of the barrel 12. An annular gap 120 is defined between the flashlight 20 and an inner periphery of the barrel 12 so that water can be filled therein. An annular passage 25 is defined in the connection area of the head member 22 and the front open end of the barrel 12 and in communication between the annular gap 120 and an interior of the head member 22. A pattern plate 23 includes apertures defined therethrough and has a central hole 231 with which the head member 22 is engaged. The pattern plate 23 is rested on an end of the head member 22 and positioned by threadedly connecting a locking member 24 to a threaded outer periphery 221 defined in the head member 22.

The head portion 40 includes a socket 41 and a bulb 42 is received in the socket 41. A seal ring 43 is located in an inner bottom of the socket 41 so as to prevent the bulb 42 from contacting water. A cap 45 is threadedly connected to the socket 41 and a reflector 44 having a reflective surface is engaged with the cap 45. The bulb 42 extends through the reflector 44 and is located in a focus position of the reflective surface of the reflector 44. A first conductive member 411 extends from the bulb 42 and is connected to an end of the batteries received in the body 21. A second conductive member 412 has a first end extending from the bulb 42 and a second end of the second conductive member 412 is extended to a rear end of the body 21.

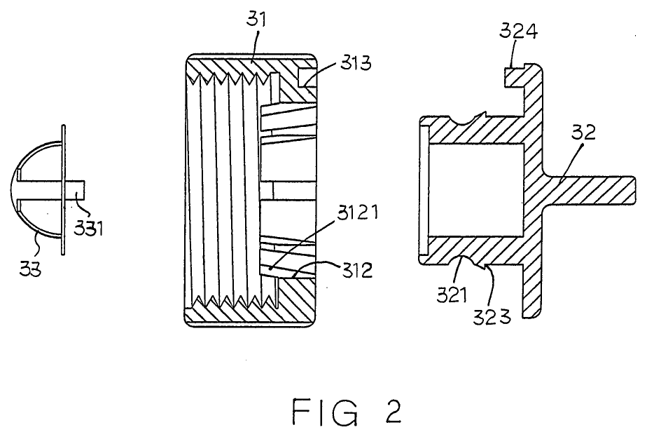

Further referring to FIG. 2, a control set 30 is rotatably connected to a rear end of the barrel 12 so as to control the flashlight 20. The control set 30 includes an end collar 31 which is threadedly connected to a threaded outer periphery 121 at the rear end of the barrel 12, and a switch member 32 is rotatably connected to the end collar 31. The end collar 31 includes an annular recess 313 defined in an end thereof and the switch member 32 includes an insertion 324 which is movably engaged with the annular recess 313. The end collar 31 further includes an opening 312 which includes a tapered inner periphery 3121, and the switch member 32 includes a tubular portion which extends through the opening 312 of the end collar 31. A tapered flange 323 extends from the tubular portion so as to match with the tapered inner periphery 3121. A seal ring 322 is mounted to the tubular portion and engaged with a groove 321 defined in the tubular portion so as to prevent from water entering this space. A contact member 33 is connected to a distal end of the tubular portion of the switch member 32 and in contact with the second end of the batteries in the body 21. A contact piece 331 extends from the contact 33 so that when rotating the switch member 32, the contact piece 331 removably contacts the second end of the second conductive member 412 and the bulb 42 is activated.

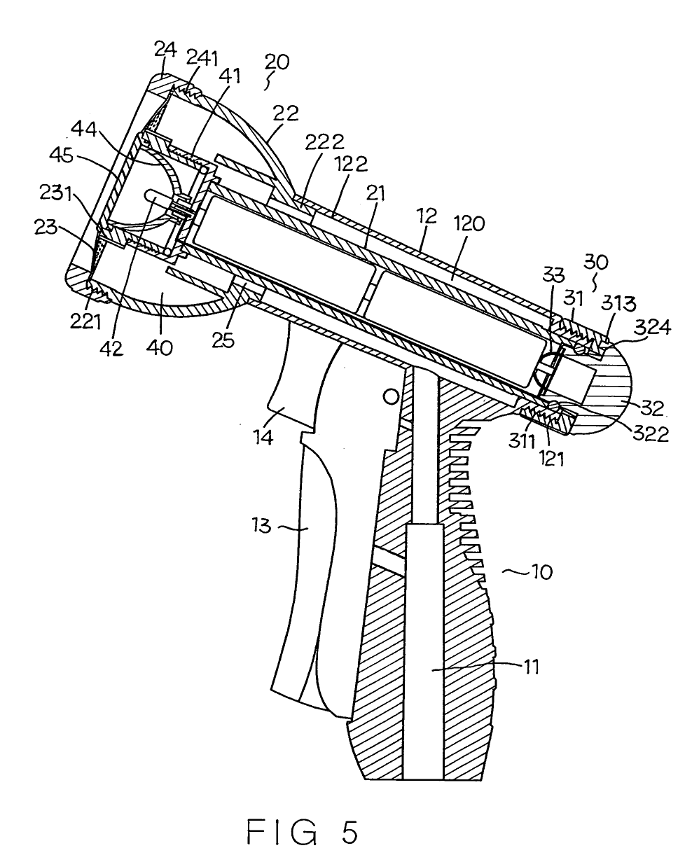

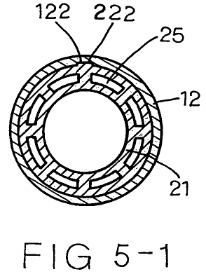

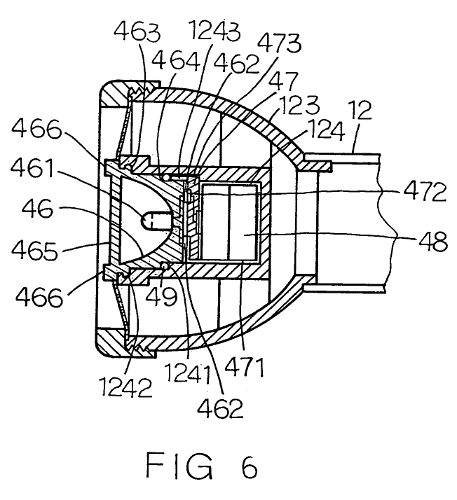

FIG. 6 shows another embodiment of the present invention wherein the flashlight is shorter than that disclosed in that in FIG. 5 and includes a body 124 received in the head member 123 and a reflector unit 46 is rotatably engaged with a front end of the body 124. The reflector unit 46 includes a flange 463 extending outward therefrom and the body 124 includes a groove 1242 defined in an inner periphery thereof so that the flange 463 of the reflector unit 46 is rotatably engaged with the groove 1242. The reflector unit 46 has a reflective surface defined in a front end thereof and a bulb 461 is located in a focus position of the reflective surface in the reflector unit 46. Two pole members 462 electrically connected to the bulb 461 extend from a rear end of the reflector unit 46. The reflector unit 46 further includes a first shoulder portion 464 in an outer periphery thereof and the body 124 includes a second shoulder portion 1241 in an inner periphery thereof, the first and second shoulder portions 464, 1241 being engaged with each other with a seal ring 49 clamped therebetween. A conduction piece 47 includes a positioning member 473 and the body 124 has a guide slot 1243 defined in the inner periphery thereof so that the positioning member 473 is inserted in the guide slot 1243 to position the conduction piece 47 in the body 124. The conduction piece 47 has two conductive members 471, 472 which are electrically connected to a battery 48 received in the body 124. The reflector unit 46 has a lens 465 at the front end thereof and includes two protrusions 466 extending from a periphery of the front surface so that the user may rotate the reflector unit 46 by pushing the protrusions 466. The two pole members 462 can removably contact the two conductive members 471, 472 by rotating the reflector unit 46.

While we have shown and described the embodiment in accordance with the present invention, it should be clear to those skilled in the art that further embodiments may be made without departing from the scope of the present invention.

1. A multi-function nozzle comprising:
a handle and a barrel which is connected to the handle, a passage defined through the handle and communicating with a hollow interior of the barrel;
a head member connected to a front open end of the barrel and a pattern plate engaged with the head member, and
a flashlight located in the head member and connected to the pattern plate.

2. The nozzle as claimed in claim 1, wherein the flashlight has a body and a head portion, the body received in the barrel and the head portion of the flashlight extending from a front open end of the barrel, an annular gap defined between the flashlight and an inner periphery of the barrel, an annular passage being in communication between the annular gap and an interior of the head member, a control set rotatably connected to a rear end of the barrel so as to control the flashlight.

3. The nozzle as claimed in claim 2, wherein the pattern plate has a central hole with which the head portion 40 of the flashlight is engaged.

4. The nozzle as claimed in claim 1, wherein the head member includes a tongue extending from a rear end thereof and a recess is defined in the inner periphery of the barrel so that the tongue is engaged with the recess.

5. The nozzle as claimed in claim 1, wherein the head member includes a threaded outer periphery and the pattern plate is rested on an end of the head member, a locking member threadedly connected to the threaded outer periphery of the head member so as to position the pattern plate.

6. The nozzle as claimed in claim 2, wherein the head portion includes a socket and a bulb is received in the socket, a cap threadedly connected to the socket and a reflector having a reflective surface engaged with the cap, the bulb extending through the reflector and located in a focus position of the reflective surface of the reflector.

7. The nozzle as claimed in claim 6 further comprising a first conductive member extends from the bulb and adapted to be connected to an end of battery received in the body, a second conductive member having a first end extending from the bulb and a second end of the second conductive member being extended to a rear end of the body, the control set adapted to contact the other end of the battery in the body and including a contact piece which removably contacts the second end of the second conductive member.

8. The nozzle as claimed in claim 7, wherein the control set includes an end collar threadedly connected to a threaded outer periphery at the rear end of the barrel and a switch member rotatably connected to the end collar, a contact member connected to the switch member and adapted to contact the second end of the battery in the body, the contact piece extending from the contact.

9. The nozzle as claimed in claim 8, wherein the end collar includes an annular recess defined in an end thereof and the switch member includes an insertion which is movably engaged with the annular recess.

10. The nozzle as claimed in claim 8, wherein the end collar includes an opening which includes a tapered inner periphery, the switch member including a tubular portion which extends through the opening of the end collar and a tapered flange extending from the tubular portion and matched with the tapered inner periphery.

11. The nozzle as claimed in claim 1, wherein the flashlight includes a body received in the head member and a reflector unit rotatably engaged with a front end of the body, the reflector unit having a reflective surface defined in a front end thereof, a bulb located in a focus position of the reflective surface in the reflector unit and two pole members extending from an rear end of the reflector unit, a conduction piece located in the body and having two conductive members which are electrically connected to a battery received in the body, the two pole members removably contacting the two conductive members by rotating the reflector unit.

12. The nozzle as claimed in claim 11, wherein the reflector unit includes two protrusions extending from a front surface thereof.

13. The nozzle as claimed in claim 11, wherein the conduction piece includes a positioning member and the body has a guide slot defined in an inner periphery thereof, the positioning member inserted in the guide slot.

14. The nozzle as claimed in claim 11, wherein the reflector unit includes a flange extending outward therefrom and the body includes a groove defined in an inner periphery thereof so that the flange of the reflector unit is rotatably engaged with the groove.

15. The nozzle as claimed in claim 11, wherein the reflector unit includes a first shoulder portion in an outer periphery thereof and the body includes a second shoulder portion in an inner periphery thereof, the first and second shoulder portions being engaged with each other with a seal ring clamped therebetween.
